(19) United States
(12) Patent Application Publication
(10) Pub. No.: US 2017/0044305 A1
(43) Pub. Date: Feb. 16, 2017

(54) COMPOSITION FOR MANUFACTURING EPOXY/ANHYDRIDE VITRIMER RESINS INCLUDING AN ORGANIC CATALYST

(71) Applicant: Arkema France, Colombes (FR)

(72) Inventors: Christophe DUQUENNE, Paris (FR); Michel Melas, Verneuil En Halatte (FR); Philippe Gentilhomme, Brenouille (FR); Jean-Pierre Disson, Vernaison (FR)

(73) Assignee: Arkema France, Colombes (FR)

(21) Appl. No.: 15/305,995

(22) PCT Filed: Apr. 9, 2015
(86) PCT No.: PCT/FR2015/050951

§ 371 Date: Oct. 21, 2016

(30) Foreign Application Priority Data
Apr. 24, 2014 (FR) 1453676

(51) Int. Cl. C08G 59/42; C08G 59/24; C08G 59/68

(52) U.S. Cl. CPC C08G 59/4238; C08G 59/686; C08G 59/245

(57) ABSTRACT

The present invention relates to a composition containing, in addition to a thermosetting epoxy resin and an anhydride hardener, at least one vitrimer-effect organic catalyst. Said composition enables vitrimer resins to be manufactured, i.e., resins that are deformable in the thermoset state. Said invention also relates to a kit for manufacturing said composition, to an object obtained from said composition and to a kit for manufacturing said object.

### FIELD OF THE INVENTION

The present invention relates to a composition containing, in addition to a thermosetting resin of epoxy type and a curing agent of anhydride type, at least one vitrimer effect organic catalyst. This composition allows the production of vitrimer resins, that is to say of resins that can be deformed in the thermoset state.

### TECHNICAL BACKGROUND

Thermoset resins (or thermosets) have the advantage of having a high mechanical strength and a high thermal and chemical resistance and, for this reason, can replace metals in certain applications. They have the advantage of being lighter than metals. They can also be used as matrices in composite materials, as adhesives, and as coatings. Among the thermoset polymers, mention may be made of unsaturated polyesters, phenoplasts, polyepoxides, polyurethanes and aminoplasts.

Conventional thermosetting resins must be processed; in particular, they must be molded so as to immediately obtain the shape appropriate for the final use. This is because transformation is no longer possible once the resin is polymerized, or thermoset, other than machining which often remains difficult. Soft or hard parts and composites based on thermosetting resins can neither be transformed nor shaped; they cannot be recycled or welded.

In parallel to thermosetting resins, a class of polymer materials, thermoplastics, has been developed. Thermoplastics can be formed at high temperature by molding or by injection-molding, but have mechanical and thermal and chemical resistance properties that are less advantageous than those of thermoset resins.

In addition, the forming of thermoplastics can only be carried out in very narrow temperature ranges. This is because, when they are heated, thermoplastics become liquids, the fluidity of which varies abruptly in the region of the melting points and glass transition temperatures, thereby making it impossible to apply to them a whole variety of transformation methods that exist for glass and for metals for example. However, molten thermoplastic resins have viscosities that are generally too high to lend themselves to the impregnation of fabrics for the purpose of obtaining composite materials.

In this context, vitrimer resins have been designed for the purpose of allying the advantages of both thermosets and thermoplastics. These materials have both the mechanical and solvent-resistance properties of thermoset resins and the capacity to be reshaped and/or repaired of thermoplastic materials. These polymer materials which are capable of indefinitely going from a solid state to a viscoelastic liquid, like glass, have been denoted “vitrimers”. Contrary to thermoplastics, the viscosity of vitrimers varies slowly with temperature, thereby making it possible to use them for the production of objects that have specific shapes incompatible with a molding process, without using a mold or precisely controlling the forming temperature.

The specific properties of vitrimers are linked to the capacity of their network to reorganize above a certain temperature, without modifying the number of intramolecular bonds or depolymerizing, under the effect of internal exchange reactions. These reactions lead to a relaxing of the stresses within the material which becomes malleable, while preserving its integrity and remaining insoluble in any solvent. These reactions are made possible by the presence of a catalyst. In the case of vitrimers of epoxy-anhydride type, obtained from a thermosetting resin of epoxy type and from a curing agent of anhydride type, it has been suggested to use, as catalyst, a zinc, tin, magnesium, cobalt, calcium, titanium or zirconium metal salt, preferably zinc acetylacetonate (WO 2012/101078). Likewise, various catalysts have been suggested for use in hybrid thermoset/supramolecular systems obtained from a thermosetting resin, from a curing agent of anhydride type or preferably of acid type and from a compound comprising an associative group and a function allowing grafting thereof onto the thermosetting resin (WO 2012/152859). These catalysts may be of organic or inorganic nature and may in particular be triazabicyclodecene (TBD), although zinc acetylacetonate is here again preferred. It has also been proposed to use TBD as catalyst in systems based on epoxy resin and an acid curing agent (M. Capelot et al., ACS Macro Lett. 2012, 1, 789-792). In this application, the TBD is used in an amount of 5 mol % relative to the number of moles of epoxy functions in the thermosetting resin. There was no reason to think that this catalyst could be used in a system based on epoxy resin and on a curing agent of anhydride and non-acid type, since the reactions within these two systems are very different and result in particular in a diester network and in hydroxy monoesters, respectively. In addition, it was not foreseeable that this catalyst could be used in systems based on a curing agent of anhydride type in a much lower amount than in systems based on a curing agent of acid type. Furthermore, TBD has a boiling point of 125-130° C., and it would have been expected that its incorporation into an epoxy-anhydride system would be accompanied by limitations to the temperature at which it could be used, otherwise cracks, bubbles or deformations might appear.

However, the inventors have demonstrated that the use of TBD as a catalyst in epoxy-anhydride systems makes it possible to obtain materials which have improved vitrimer properties compared to the materials obtained using zinc acetylacetonate, in the sense that the stresses developed within the materials were more completely and more rapidly relaxed, this being at lower catalyst contents. The materials obtained using TBD thus exhibit better deformation properties, which are more compatible with an industrial thermoforming process, which requires very rapid deformation and relaxation of the stresses at the industrial rates used.

In addition, this deformation capacity is not obtained to the detriment of the crosslinking density, and therefore of the mechanical properties of the material, which can moreover be modulated by adjusting the TBD content.

Furthermore, another drawback of zinc acetylacetonate is the fact that at the temperatures (from 250 to 350° C.) required for transformation, this catalyst is not sufficiently stable, thereby causing gas to be given off during hot manipulations of the material, resulting in a loss of mass measured in particular by thermogravimetric analysis (TGA). It has been observed that TBD exhibits better thermal stability than zinc acetylacetonate.

### DEFINITIONS

The term “thermosetting” resin is intended to mean a monomer, oligomer, prepolymer, polymer or any macromolecule capable of being chemically crosslinked. It is more preferentially intended to mean a monomer, oligomer, prepolymer, polymer or any macromolecule capable of being chemically crosslinked when it is reacted with a curing agent (also called crosslinking agent) in the presence of an energy source, for example heat or radiation, and optionally of a catalyst.

The term “thermoset” resin or resin “in the thermoset state” is intended to mean a thermosetting resin chemically crosslinked such that its gel point is reached or exceeded. The term “gel point” is intended to mean the degree of crosslinking starting from which the resin is virtually no longer soluble in solvents. Any method conventionally used by those skilled in the art may be carried out in order to verify it. The test described in application WO 97/23516, page 20, may for example be carried out. For the purposes of the invention, a resin is considered to be thermoset provided that its gel content, that is to say the percentage of its residual mass after being placed in a solvent relative to its initial mass before being placed in a solvent, is greater than or equal to 75%.

The term “curing agent” denotes a crosslinking agent capable of crosslinking a thermosetting resin. It is in this case a generally polyfunctional compound, bearing reactive anhydride functions capable of reacting with reactive functions borne by the resin.

When reference is made to ranges, expressions of the type “ranging from . . . to . . . ” include the limits of the range. Expressions of the type “between . . . and . . . ” exclude the limits of the range.

### SUMMARY OF THE INVENTION

The first subject of the invention is a composition comprising at least:

a catalyst comprising, and preferably consisting of, a compound of formula (I):

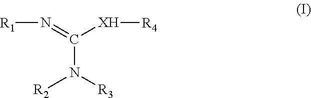

in which:
X denotes a nitrogen atom or a —CH— group, preferably X is the atom N,
R₁ denotes a hydrogen atom or a C₁-C₆ alkyl group or a phenyl group that can be substituted with a C₁-C₄ alkyl group,
R₂, R₃ and R₄ independently denote a hydrogen atom, a C₁-C₆ alkyl group, or a phenyl group that can be substituted with a C₁-C₄ alkyl group, or an acetyl group,
or R₁ and R₂ form, together and with the atoms to which they are bonded, a saturated or unsaturated heterocycle and/or R₃ and R₄ form, together and with the atoms to which they are bonded, a saturated or unsaturated heterocycle,

a thermosetting resin comprising at least one and advantageously several epoxide functions and optionally at least one and advantageously several free hydroxyl and/or ester functions, and a thermosetting-resin curing agent chosen from carboxylic acid anhydrides.

The above catalyst will hereinafter be denoted “vitrimer effect organic catalyst” or “vitrimer effect catalyst”. The vitrimer effect catalyst facilitates the internal exchange reactions within a thermoset resin so as to make it deformable. It is understood that this catalyst is present, in the composition of the invention, in addition to the catalysts that may already be present intrinsically in the thermosetting resin and/or in the curing agent, due to the fact that the preparation thereof can be carried out in the presence of catalysts in a low content, or in addition to the conventional epoxide ring opening catalysts.

A subject of the invention is also a kit for producing such a composition, comprising at least:

a first composition comprising the catalyst, alone or with the curing agent or the thermosetting resin;

optionally a second composition comprising the curing agent;

optionally a third composition comprising the thermosetting resin.

Another subject of the invention is the use of the abovementioned composition for producing an object made of thermoset resin that is hot-deformable, and also an object comprising a thermoset resin obtained from the composition according to the invention.

Another subject of the invention is a process for deforming an object as defined above, such as an assembly, welding, repairing or recycling process, comprising the application, to this object, of a mechanical stress at a temperature (T) above the glass transition temperature Tg of the thermoset resin.

Finally, a subject of the invention is the use of one or more objects as described above in the motor vehicle, aeronautical, nautical, aerospace, sport, construction, electrical, electrical insulation, electronics, wind power, packaging or printing fields.

### DETAILED DESCRIPTION

As previously indicated, the composition according to the invention contains a vitrimer effect catalyst, of formula (I):

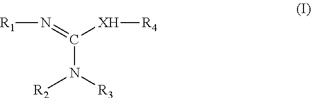

in which:
X denotes a nitrogen atom or a —CH— group,
R₁ denotes a hydrogen atom or a C₁-C₆ alkyl group or a phenyl group that can be substituted with a C₁-C₄ alkyl group,
R₂, R₃ and R₄ independently denote a hydrogen atom, a C₁-C₆ alkyl group, or a phenyl group that can be substituted with a C₁-C₄ alkyl group, or an acetyl group,
or R₁ and R₂ form, together and with the atoms to which they are bonded, a saturated or unsaturated heterocycle and/or R₃ and R₄ form, together and with the atoms to which they are bonded, a saturated or unsaturated heterocycle.

Preferably, R₁ and R₂ form, together and with the atoms to which they are bonded, a saturated or unsaturated, preferably unsaturated, heterocycle, and R₃ and R₄ form, together and with the atoms to which they are bonded, a saturated or unsaturated, preferably saturated, heterocycle.

Preferably, the C₁-C₆ alkyl or phenyl groups are not substituted and the R₁ and R₂ groups do not contain a nitrogen atom.

Examples of vitrimer effect catalysts that can be used in the present invention are the following:

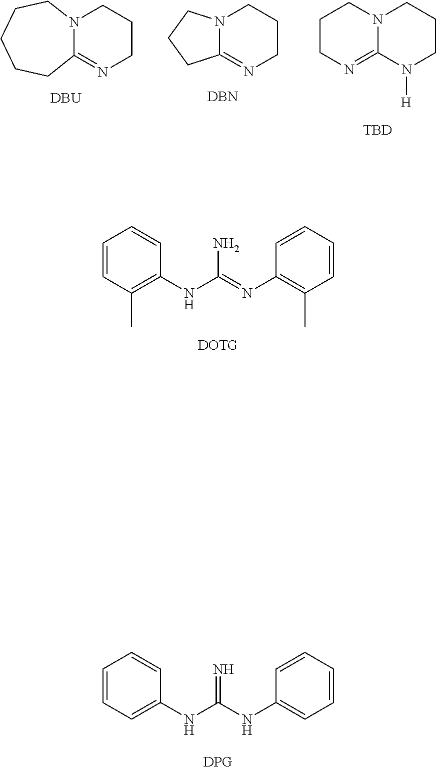

These catalysts may also be denoted catalysts of guanidine type.

Preferentially, the vitrimer effect catalyst is triazabicyclodecene (TBD).

According to one embodiment of the invention, the catalyst represents from 0.1 to less than 5 mol %, preferably from 0.1 to 4 mol %, more preferentially from 0.5 to 2 mol %, relative to the molar amount of epoxy functions contained in said thermosetting resin.

The composition according to the invention comprises at least one curing agent of carboxylic acid anhydride type (comprising at least one —C(O)—O—C(O)— function).

As curing agents of anhydride type, mention may in particular be made of cyclic anhydrides, for instance phthalic anhydride, nadic or methylnadic anhydride, dodecenylsuccinic anhydride (DDSA), glutaric anhydride; partially or totally hydrogenated aromatic anhydrides such as tetrahydrophthalic anhydride, or methyltetrahydrophthalic anhydride, hexahydrophthalic anhydride or methylhexahydrophthalic anhydride; and mixtures thereof.

As curing agents of anhydride type, mention may also be made of succinic anhydride, maleic anhydride, trimellitic anhydride, the adduct of trimellitic anhydride and of ethylene glycol, chlorendic anhydride, tetrachlorophthalic anhydride, pyromellitic dianhydride (PMDA), 1,2,3,4 cyclopentanetetracarboxylic acid dianhydride, aliphatic acid polyanhydrides such as polyazelaic polyanhydride, polysebacic polyanhydride and mixtures thereof.

Use may in particular be made of the anhydrides having the following formulae, and mixtures thereof:

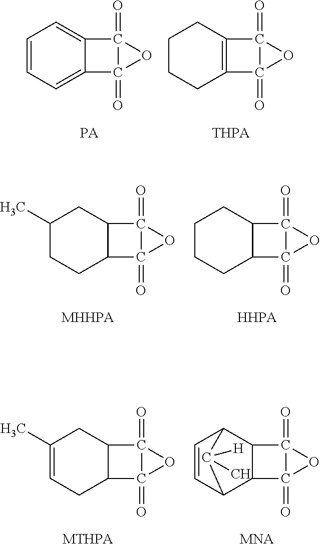

and more preferentially MTHPA.

As curing agent of anhydride type, mention may also be made of the curing agent of commercial reference HY905 sold by Huntsman, which is a liquid mixture of several anhydrides.

Advantageously, the amount of curing agent is such that the number of moles of epoxide functions of the resin can range from 50 to 300%, preferably from 100% to 200%, preferably from 125 to 150%, relative to the number of moles of anhydride functions of the curing agent.

The composition according to the invention comprises at least one thermosetting resin comprising at least one and advantageously several epoxide functions and optionally at least one and advantageously several free hydroxyl functions and/or ester functions. Such a resin will be denoted “epoxy resin”.

Advantageously, the epoxy resin represents at least 10% by weight, at least 20% by weight, at least 40% by weight, at least 60% by weight, or even 100% by weight, of the total weight of thermosetting resin present in the composition.

There are two major categories of epoxy resins: epoxy resins of glycidyl type, and epoxy resins of non-glycidyl type. The epoxy resins of glycidyl type are themselves categorized as glycidyl ether, glycidyl ester and glycidyl amine. The non-glycidyl epoxy resins are of aliphatic or cycloaliphatic type. The glycidyl epoxy resins are prepared by means of a condensation reaction of a diol, diacid or diamine with epichlorohydrin. The non-glycidyl epoxy resins are formed by peroxidation of the olefinic double bonds of a polymer.

Among the glycidyl epoxy ethers, bisphenol A diglycidyl ether (DGEBA) represented below is most commonly used.

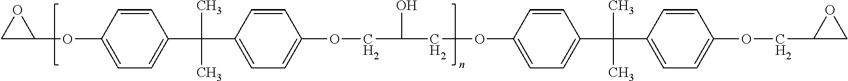

DGEBA-based resins have excellent electrical properties, low shrinkage, good adhesion on numerous metals, good moisture resistance, good resistance to mechanical impacts and good heat resistance.

The properties of DGEBA resins depend on the value of the degree of polymerization n, which itself depends on the stoichiometry of the synthesis reaction. Generally, n varies from 0 to 25.

Novolac epoxy resins (the formula of which is represented below) are glycidyl ethers of Novolac phenolic resins. They are obtained by reaction of phenol with formaldehyde in the presence of an acid catalyst so as to produce a Novolac phenolic resin, followed by a reaction with epichlorohydrin in the presence of sodium hydroxide as catalyst.

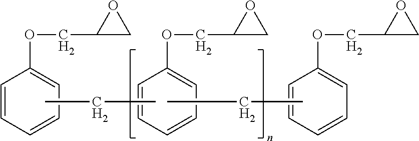

The Novolac epoxy resins generally contain several epoxide groups. The multiple epoxide groups make it possible to produce thermoset resins of high crosslinking density. The Novolac epoxy resins are widely used to produce materials for microelectronics because of their greater strength at a high temperature, their excellent molding ability, and their greater mechanical, electrical, heat-resistance and moisture-resistance properties.

The thermosetting resin that can be used in the present invention can for example be chosen from: Novolac epoxy resins, bisphenol A diglycidyl ether (DGEBA), hydrogenated bisphenol A diglycidyl ether, bisphenol F diglycidyl ether, tetraglycidyl methylene dianiline, pentaerythritol tetraglycidyl ether, trimethylol triglycidyl ether (TMPTGE), tetrabromo bisphenol A diglycidyl ether, or hydroquinone diglycidyl ether, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether, polypropylene glycol diglycidyl ether, polytetramethylene glycol diglycidyl ether, resorcinol diglycidyl ether, neopentyl glycol diglycidyl ether, bisphenol A polyethylene glycol diglycidyl ether, bisphenol A polypropylene glycol diglycidyl ether, terephthalic acid diglycidyl ester, poly(glycidyl acrylate), poly(glycidyl methacrylate), epoxidized polyunsaturated fatty acids, epoxidized vegetable oils, in particular epoxidized soybean oil, epoxidized fish oils, and epoxidized limonene; glycidyl esters of versatic acid, such as those sold under the name Cardura® E8, E10 or E12 by the company Momentive (Cardura® E10 having CAS 26761-45-5); the epoxidized cycloaliphatic resins sold under the name Araldite® CY179, CY184, MY0510 and MY720 by the company Huntsman, the resins CY179 and CY184 corresponding respectively to the following formulae:

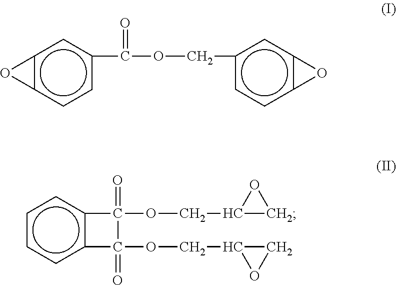

triglycidyl isocyanurate (TGIC); glycidyl methacrylate, alkoxylated glycidyl (meth)acrylates; C₈-C₁₀ alkyl glycidyl ethers, C₁₂-C₁₄ alkyl glycidyl ethers, neodecanoic acid glycidyl ester, butyl glycidyl ether, cresyl glycidyl ether, phenyl glycidyl ether, p-nonylphenyl glycidyl ether, p-nonylphenyl glycidyl ether, p-t-butyl phenyl glycidyl ether, 2-ethylhexyl glycidyl ether, neopentyl glycol diglycidyl ether, acid dimer diglycidyl ester, cyclohexanedimethanol diglycidyl ether, castor oil polyglycidyl ether; and mixtures of the abovementioned resins.

Advantageously, it is more particularly chosen from: DGEBA, bisphenol F diglycidyl ether, Novolac resins, TMPTGE, 1,4-butanediol diglycidyl ether, Araldite® CY184 of formula (II) above, TGIC, epoxidized soybean oil, and mixtures thereof. Even more preferentially, it is DGEBA.

According to one embodiment, the composition consists of the vitrimer effect catalyst, the curing agent and a thermosetting epoxy resin, as defined above. According to this embodiment, the number of moles of catalyst can range from 0.1 to 10%, preferably from 0.5 to 5%, preferably from 0.5 to 2%, relative to the number of moles of anhydride functions. The number of moles of epoxide functions of the resin can range from 50 to 300%, preferably from 100% to 200%, preferably from 125 to 150%, relative to the number of moles of anhydride functions of the curing agent.

The composition of the invention can optionally comprise one or more additional compounds, insofar as their presence does not impair the advantageous properties which ensue from the invention. Examples of such additional compounds are: polymers, pigments, dyes, fillers, plasticizers, long or short, woven or nonwoven fibers, flame retardants, antioxidants, lubricants, wood, glass, metals, and mixtures thereof.

Advantageously, the content of thermosetting resin and of curing agent ranges from 10% to 90% by weight, in particular from 20% to 80% by weight or even from 30% to 70% by weight, relative to the total weight of the composition, the remainder to 100% being provided by the catalyst and optionally by additional compounds chosen from the abovementioned compounds.

Among the polymers that can be used as a mixture with the composition of the invention, mention may be made of: elastomers, thermoplastics, thermoplastic elastomers, and impact additives.

The term “pigment” is intended to mean colored particles that are insoluble in the composition of the invention. As pigments that can be used according to the invention, mention may be made of titanium oxide, carbon black, carbon nanotubes, metal particles, silica, metal oxides, metal sulfides or any other mineral pigment; mention may also be made of phthalocyanines, anthraquinones, quinacridones, dioxazines, azo pigments or any other organic pigment, natural pigments (madder, indigo, murex, cochineal, etc.) and pigment mixtures.

The term “dyes” is intended to mean molecules that are soluble in the composition of the invention and that have the ability to absorb a part of the visible radiation range.

Among the fillers that can be used in the composition of the invention, mention may be made of the fillers conventionally used in polymer formulations. Mention may be made, without this being limiting, of: silica, clays, carbon black, kaolin, talc, calcium carbonate, whiskers, and mixtures thereof.

Among the fibers that can be used in the composition of the invention, mention may be made of: glass fibers, carbon fibers, polyester fibers, polyamide fibers, aramid fibers, cellulose-based and nanocellulose-based fibers or else plant fibers (flax, hemp, sisal, bamboo, etc.), and mixtures thereof.

The presence, in the composition of the invention, of pigments, dyes or fibers capable of absorbing radiation, or mixtures thereof, can serve to perform the heating of a material or of an object produced from such a composition, by means of a radiation source such as a laser.

The presence, in the composition of the invention, of electricity-conducting pigments, fibers or fillers, such as carbon black, carbon nanotubes, carbon fibers, metal powders, magnetic particles, or mixtures thereof, can be used to perform the heating of a material or of an object produced from such a composition, by the Joule effect, by induction or by microwaves. Such heating can make it possible to carry out a process for producing, transforming or recycling a material or an object according to a process that will be described later.

The additional compounds can also be chosen from one or more other catalysts and/or curing agents, of any nature known to those skilled in the art as performing these roles insofar as they do not impair the advantageous properties which ensue from the invention. They will be denoted “additional catalyst” and “additional curing agent”.

According to one preferred embodiment of the invention, the composition described herein also contains one or more additional catalysts which are specific for epoxide opening, such as:

optionally blocked tertiary amines, for instance: 2,4,6-tris(dimethylaminomethyl)phenol (for example sold under the name Ancamine), o-(dimethylaminomethyl)phenol, benzyldimethylamine (BDMA), 1,4-diazabicyclo(2,2,2)octane (DABCO), methyltribenzylammonium chloride;

imidazoles, such as 2-methylimidazole (2-MI), 2-phenylimidazole 2-ethyl-4-methylimidazole (EMI), 1-propylimidazole, 1-ethyl-3-methylimidazolium chloride, 1-(2-hydroxypropyl)imidazole;

phosphoniums: tetraalkyl- and alkyltriphenylphosphonium halides;

polyacid amine salts, aniline-formaldehyde condensates, N,N-alkanolamines, trialkanolamine borates, fluoroborates such as boron trifluoride monoethylamine (BF3-MEA), organosubstituted phosphines, quaternary monoimidazoline salts, mercaptans, polysulfides;

and mixtures thereof.

Preferentially, the epoxide-opening catalyst is chosen from: tertiary amines, imidazoles, and mixtures thereof.

(Hetero)aromatic amines, such as 2-methylimidazole and tris(dimethylaminomethyl)phenol, are more particularly preferred for use in this invention.

This epoxide-opening additional catalyst is advantageously used in the composition in a proportion of from 0.1 mol % to 5 mol % relative to the number of moles of epoxide functions borne by the thermosetting resin.

Use may also be made of one or more vitrimer effect additional catalysts chosen from the catalysts mentioned in applications WO2011/151584, WO2012/101078 and WO 2012/152859, always insofar as their presence does not impair the advantageous properties which ensue from the invention.

The vitrimer effect additional catalyst can for example be present in the composition of the invention in a proportion of from 0.1 to 10% by weight and preferably from 0.1 to 5% by weight relative to the total weight of the composition.

Moreover, the use of an additional curing agent makes it possible to obtain, for the materials ultimately produced, a wide range of mechanical properties at ambient temperature (for example control of the glass transition temperature and/or of the modulus of a thermosetting resin).

As examples of additional curing agents, mention may be made of epoxy resin curing agents, in particular those chosen from amines, polyamides, polycarboxylic acids, phenolic resins, anhydrides (optionally other than those described above as acid curing agents), isocyanates, polymercaptans, dicyanodiamides, and mixtures thereof.

In particular, an additional curing agent of amine type can be chosen from primary or secondary amines having at least one —NH₂ function or two —NH functions and from 2 to 40 carbon atoms. These amines can for example be chosen from aliphatic amines such as diethylenetriamine, triethylenetetramine tetraethylenepentamine, dihexylenetriamine, cadaverine, putrescine, hexanediamine, spermine, isophorone diamine, and also aromatic amines such as phenylenediamine, diaminodiphenylmethane, diaminodiphenylsulfone, methylenebischlorodiethylaniline, metaxylylenediamine (MXDA) and hydrogenated derivatives thereof such as 1,3-bis(aminomethylcyclohexane) (1,3-BAC); and mixtures thereof.

An additional curing agent of amine type can also be chosen from polyetheramines, for example the Jeffamines from Huntsman, optionally as a mixture with other additional curing agents.

As preferred additional curing agents, mention may be made of diethylenetriamine, triethylenetetramine, hexanediamine, and mixtures thereof.

According to one preferred embodiment of the invention, the composition described herein also contains at least one polyol, that is to say a compound comprising at least two hydroxyl functions, in particular a linear or branched polyhydroxyalkane, such as glycerol, trimethylolpropane or pentaerythritol. It has in fact been observed that the addition of this compound to the reaction mixture makes it possible to further improve the vitrimer properties of the material, that is to say to obtain a material capable of more completely and more rapidly relaxing the stresses after application of a deformation.

### Process for Preparing the Composition

The compounds of the composition according to the invention are either commercially available, or can be easily synthesized by those skilled in the art starting from commercially available raw materials.

The composition of the invention can be obtained by simply bringing the compounds that it contains into contact. This bringing into contact is preferably carried out at a temperature ranging from 15° C. to 130° C., in particular from 50° C. to 125° C. The bringing into contact can be carried out with or without homogenization means.

According to one particular embodiment, the process comprises a first step during which the vitrimer effect catalyst is pre-introduced into the resin or the curing agent, preferably into the curing agent. The catalyst can then be in the form of a dispersion if it is a powder, or a solution. This dispersion or dissolving can be carried out at ambient temperature or under hot conditions in order to obtain the desired viscosity characteristics.

### Kits

The composition in accordance with the invention can be prepared from a kit comprising at least:

a first composition comprising the catalyst, alone or with the curing agent or the thermosetting resin;

optionally a second composition comprising the curing agent;

optionally a third composition comprising the thermosetting resin.

It is also possible to provide for a kit for producing an object in accordance with the invention, comprising at least:

first composition comprising the catalyst, alone or with the curing agent or the thermosetting resin;

optionally a second composition comprising the curing agent;

optionally a third composition comprising the thermosetting resin.

The various compositions can be stored together or separately. It is also possible to store some of the compositions together, while at the same time keeping them separate from the other compositions.

The various compositions are generally stored at ambient temperature.

Preferably, when the second and third compositions are both present in the kit, they are in a packaging suitable for preventing a crosslinking reaction between the thermosetting resin and the curing agent from taking place without the intervention of an operator.

The packaging can consist of a container comprising two or even three internal compartments enabling separate storage of each of the compositions. According to one variant, the kit can consist of one single container, containing a mixture, in appropriate amounts, of the two or three compositions. In this latter case, the intervention of the operator is advantageously limited to heating.

It is possible to provide for a means for bringing the contents of the various compartments into contact, advantageously in such a way as to make it possible to initiate the crosslinking in the container.

It is also possible to provide for a kit consisting of several distinct bottles combined in the same packaging and each comprising the suitable amounts of each of the compositions for preparing the composition of the invention, so as to avoid the user having to perform weighing out and/or metering out operations.

### Uses

The composition described above can be used for producing an object made of thermoset resin that is hot-deformable.

The thermoset resin obtained from the composition according to the invention is hot-deformable.

The term “hot-deformable” is intended to mean at a temperature (T) above the glass transition temperature Tg of the thermoset resin.

The thermoset resin obtained from the composition according to the invention advantageously has:
a glass transition temperature (Tg) of between 60 and 170° C., preferably between 80 and 150° C., more preferentially between 100 and 140° C.,
a relaxation time t necessary for obtaining a normalized stress value equal to 1/e at a temperature equal to Tg+100° C. and/or to 200° C., which is less than 5000 seconds, preferably less than 2000 seconds, more preferentially less than 1000 seconds,
a percentage of relaxed stresses a after 5000 seconds at a temperature equal to Tg+100° C. and/or to 200° C., which is at least 80%, preferably at least 90%, more preferentially at least 95%, or even 100%,
a storage modulus (G′) at the rubbery plateau, for example at a temperature of between 150 and 200° C., that is greater than 5 MPa, preferably greater than or equal to 10 MPa, or even greater than or equal to 15 MPa,

these magnitudes being measured according to the protocols indicated in the examples hereinafter.

### Objects and Processes for the Production Thereof

The invention also relates to an object comprising a thermoset resin obtained from at least one composition in accordance with the invention.

For the purposes of the present invention, the term “object” is intended to mean a three-dimensional part. Included in this definition are coatings, films, sheets, ribbons, etc. The objects according to the invention can in particular consist of coatings deposited on a support, such as a protective layer, a paint or else an adhesive film. Also included are powders, granules, etc.

The object according to the invention can be produced according to a production process comprising:
a) preparing or making available a composition in accordance with the invention,
b) forming the composition resulting from step a),
c) applying an energy enabling curing of the resin,
d) cooling the thermoset resin.

Steps a), b) and c) of the process may be successive or simultaneous.

The preparation of the composition can be carried out in a mixer of any type known to those skilled in the art. It can in particular be carried out by bringing the compositions described in relation to the kit into contact so as to form a composition according to the invention.

The forming can be carried out by any technique known to those skilled in the art in the field of thermosetting resins, in particular by molding. Notably, the invention makes it possible to also provide for other modes of forming, such as casting, filament coiling, continuous molding or molding between film coatings, infusion, pultrusion, resin transfer molding or RTM, reaction injection molding (or RIM) or any other methods known to those skilled in the art, as described in the works “Epoxy Polymer” edited by J. P. Pascault and R. J. J. Williams, Wiley-VCH, Weinheim 2010 or “Chimie industrielle” [“Industrial chemistry”], by R. Perrin and J. P. Scharff, Dunod, Paris 1999.

The forming can consist of placing in the form of a powder or of grains by any technique known to those skilled in the art. Mechanical milling may also be carried out at the end of step d).

With regard to the forming of the composition in coating form, use may advantageously be made of any method known in the art, in particular: the application of the composition with a brush or a roller; the dipping of a support to be coated in the composition; the application of the composition in the form of a powder.

If an attempt is made to form a composition of thermoset resin of the prior art in the same way as described above, the material or the object obtained is no longer deformable nor repairable nor recyclable once the gel point of the resin is reached or exceeded. The application of a moderate temperature to such an object according to the prior art does not result in any observable or measurable transformation, and the application of a very high temperature results in degradation of this object.

Conversely, the objects of the invention, because they are produced from a composition in accordance with the invention, can be deformed, welded, repaired and recycled via an increase in their temperature.

The expression “applying an energy enabling curing of the resin” is intended to mean generally a temperature increase. The applying of an energy enabling curing of the resin can for example consist of heating at a temperature ranging from 50 to 250° C., for example from 50 to 120° C. It is also possible to carry out an activation by radiation, for example by UV rays or an electron beam, or chemically, in particular by the radical route, for example by means of peroxides.

The cooling of the thermoset resin is usually carried out by leaving the material or the object to return to ambient temperature, with or without use of a cooling means.

An object in accordance with the invention may be composite. It may in particular result from the assembly of at least two objects, at least one of which, and advantageously both of which, comprise(s) at least one thermoset resin obtained from at least one composition in accordance with the invention.

It is for example a stratified material, comprising an alternating superposition of layers of thermoset resin obtained from at least one composition in accordance with the invention, with layers of wood, metal or glass.

An object of the invention may also comprise one or more additional components chosen from those mentioned above and in particular: polymers, pigments, dyes, fillers, plasticizers, long or short, woven or nonwoven fibers, flame retardants, antioxidants, lubricants, wood, glass and metals. When such an object is produced in accordance with one of the production processes described above, the additional compounds may be introduced before, during or after step a).

### Deformation Process

The thermoset resins obtained as described herein have the advantage of exhibiting a slow variation in viscosity over a wide temperature range, which makes the behavior of an object of the invention comparable to that of inorganic glasses and makes it possible to apply thereto deformation processes which are not generally applicable to conventional thermosets.

It can thus be shaped by applying stresses of about from 1 to 10 MPa without however flowing under its own weight.

Likewise, this object can be deformed at a temperature above the temperature Tg, then in a second step, the internal stresses can be eliminated at a higher temperature.

The low viscosity of these objects at these temperatures allows in particular injection or molding under a press. It should be noted that no depolymerization is observed at high temperatures and the objects of the invention retain their crosslinked structure. This property allows the repair of an object of the invention that would be fractured into at least two parts by simple welding of these parts to one another. No mold is required to maintain the shape of the objects of the invention during the repair process at high temperatures. Likewise, an object of the invention can be transformed by application of a mechanical stress to just one part of the object without recourse to a mold, since the objects of the invention do not flow. However, large objects, which have a further tendency to sag, may be held by a frame, such as for glasswork.

Thus, the object as described above can be deformed according to a process comprising the application to the object of a mechanical stress at a temperature (T) above the temperature Tg. The assembly, welding, repair and recycling constitute a particular case of this deformation process. Preferably, in order to allow deformation in a period of time compatible with an industrial application, the deformation process comprises the application to the object of the invention of a mechanical stress at a temperature (T) above the glass transition temperature Tg of the thermoset resin that it contains.

Usually, such a deformation process is followed by a step of cooling to ambient temperature, optionally with application of at least one mechanical stress. For the purposes of the present invention, the term “mechanical stress” is intended to mean the application of a mechanical force, locally or to all or part of the object, this mechanical force aiming to form or deform the object. Among the mechanical stresses that can be used, mention may be made of: pressure, molding, blending, extrusion, blowing, injection, stamping, twisting, flexing, tensile stress and shear. It may for example be twisting applied to the object of the invention in the form of a strip. It may be a pressure applied using a plate or a mold on one or more faces of an object of the invention, or stamping of a pattern in a plate or a sheet. It may also be a pressure exerted in parallel on two objects of the invention in contact with one another so as to cause welding of these objects. In the case where the object of the invention consists of granules, the mechanical stress may consist of blending, for example in a mixer or around the screw of an extruder. It may also consist of an injection or extrusion. The mechanical stress may also consist of blowing, which may for example be applied to a sheet of the object of the invention. The mechanical stress may also consist of a multiplicity of distinct stresses, of an identical or different nature, applied simultaneously or successively to all or part of the object of the invention, or locally.

This deformation process may include a step of mixing or agglomerating the object of the invention with one or more additional components chosen from those mentioned above and in particular: polymers, pigments, dyes, fillers, plasticizers, long or short, woven or nonwoven fibers, flame retardants, antioxidants and lubricants.

The increase in temperature in the deformation process can be carried out by any known means, such as heating by conduction, convection or induction, by spot heating, infrared, microwave or radiant heating. The means for producing an increase in temperature for carrying out the processes of the invention comprise: an oven, a microwave oven, a heating resistor, a flame, an exothermic chemical reaction, a laser beam, an iron, a hot air gull, an ultrasonic bath, a heated punch, etc. The increase in temperature may optionally be carried out in steps and the duration thereof is adjusted to the expected result.

Although the resin does not flow during its deformation, by virtue of the exchange reactions, by choosing a temperature, a heating time and cooling conditions that are appropriate, the new shape can be free of any residual stress. The object is not therefore weakened or fractured by the application of the mechanical stress. In addition, if the object deformed is subsequently reheated, it will not return to its first shape. This is because the exchange reactions which occur at high temperature promote reorganization of the crosslinking points of the thermoset resin network in such a way as to abolish the mechanical stresses. A sufficient heating time makes it possible to completely abolish these internal mechanical stresses in the object which have been caused by the application of the external mechanical stress.

This method therefore makes it possible to obtain stable complex shapes which are difficult or even impossible to obtain by molding, from simpler elementary shapes. In particular, it is very difficult to obtain, by molding, shapes resulting from twisting. Additionally, the choice of appropriate conditions for temperature, heating time under stress and cooling makes it possible to transform an object of the invention while at the same time controlling the persistence of certain internal mechanical stresses within this object, then, if the object thus transformed is subsequently reheated, a further controlled deformation of this object by controlled release of the stresses can be performed.

### Recycling Processes

The object obtained according to the invention can also be recycled:

either by direct treatment of the object: for example, a broken or damaged object of the invention is repaired by means of a deformation process as described above and can thus return to its prior use function or find another function;

or the object is reduced to particles by applying mechanical milling, and the resulting particles are then used in a process for producing an object in accordance with the invention. In particular, according to this process, the particles are simultaneously subjected to an increase in temperature and to a mechanical stress enabling them to be transformed into an object in accordance with the invention.

The mechanical stress which enables the transformation of the particles into an object can for example comprise compression in a mold, blending, and/or extrusion. This method makes it possible in particular, by application of a sufficient temperature and of an appropriate mechanical stress, to mold new objects from the objects of the invention.

Another advantage of the invention is that it makes it possible to produce objects based on thermoset resin from solid raw materials. These solid raw materials are thus objects according to the invention in the form of parts, of an elementary unit or of a set of elementary units.

The term “elementary units” is intended to mean parts which have a shape and/or an appearance suitable for their subsequent transformation into an object, for instance: particles, granules, balls, sticks, plates, sheets, films, strips, rods, tubes, etc.

The term “set of elementary units” is intended to mean at least 2 elementary units, for example at least 3, at least 5, at least 10 or even at least 100 elementary units. Any process known to those skilled in the art may be used for this purpose. These elementary parts are then transformable, under the combined action of heat and a mechanical stress, into objects of the desired shape: for example, strips can by stamping be cut into smaller parts of chosen shape, sheets can be superimposed and assembled by compression. These thermoset resin-based elementary parts can be more easily stored, transported and handled than the liquid formulations from which they are derived. This is because the step of transforming the elementary parts in accordance with the invention can be carried out by the final user without chemistry equipment (non-toxicity, no expiration date, no VOC, no weighing out of reagents).

One particular case of the deformation process already described thus comprises:

a) the use, as raw material, of an object of the invention in the form of an elementary unit or of a set of elementary units,
b) the simultaneous application of a mechanical stress and of an increase in temperature so as to form the object in order to produce a new object,
c) the cooling of the object resulting from step b).

Another advantage of this process is that it enables the recycling of the new object produced, it being possible for said object to be reconditioned in the form of elementary units or parts that can in turn be re-formed, in accordance with the invention.

The process of recycling an object of the invention can comprise:

a) the use of an object of the invention as raw material,
b) the application of a mechanical stress and optionally of a simultaneous increase in temperature so as to transform this object into a set of elementary units,
c) the cooling of this set of elementary units.

### Applications

The fields of application of the present invention are mainly those of thermosetting resins, in particular those of epoxy resins, in particular the motor vehicle industry (which groups together any type of motorized vehicle, including heavy goods vehicles), aeronautics, the nautical field, aerospace, sport, construction, the electrical field, electrical insulation, electronics, wind power, packaging and printing.

The compositions, materials and objects of the invention may for example be incorporated into formulations, in particular with typical additives such as fillers, antioxidants, flame retardants, UV protectors, pigments or dyes. The formulations may for example be used for the coating of paper, and the production of inks and paints. The materials or objects of the invention can be used in the form of powders or granules, or else be incorporated into composite materials, in particular those comprising glass fibers, carbon fibers, aramid fibers or fibers of plant origin (flax fibers, hemp fibers, etc.). These fibers may be woven or nonwoven, long fibers or short fibers. The compositions of the invention may also be applied as coatings, for example as varnishes for protection of metals, protection of pipes, protection of floorings.

The compositions of the invention may also be used to produce adhesives, advantageously those which are thermo-crosslinkable or photo-crosslinkable, to encapsulate connectors (it being possible for the composition of the invention to be applied by potting or injection), to produce electrical insulator parts or else to produce prototypes.

### EXAMPLES

The following examples illustrate the invention without limiting it.

### Characterization Methods

Mechanical analysis: the samples of examples 1 to 4 were subjected to dynamic mechanical analysis (DMA). Specifically, a bar 10×30×3 mm in size was fixed between two clamps and subjected to a rectangular torsion (imposed deformation of 0.05%) in an RDA3 apparatus from Rheometric Scientific, with a frequency of 1 Hz, by carrying out a temperature scan from 25 to 250° C. with a temperature ramp of 3° C./min. The value of Tα was determined at the top of the peak of the tan δ curve, and is considered hereinafter to be the Tg of the sample, while the storage modulus G′ was determined on the rubbery plateau at 200° C.

### Example 1

### Synthesis of an Epoxy-Anhydride Network in the Presence of 1% of Organic Catalyst

Four samples of vitrimer material (respectively 1a, 1b, 1c and 1d) were prepared in the presence of 1% of TBD, according to the following method.

Added to a beaker were an epoxy resin of DGEBA type (DER332 from DOW, Mass Epoxy Equivalent: 174 g/eq) in viscous liquid form, and also TBD (Aldrich) in a proportion of 1 mol % of catalyst per mole of epoxide functions. The beaker was placed in a thermostated oil bath at 100-120° C. until dissolution of the catalyst in the resin so as to obtain a homogeneous and transparent mixture. Methyl tetrahydrophthalic anhydride (MTHPA) (MW=166.18 g/mol) was then added to this mixture, outside the bath, then the whole mixture was homogenized for a few minutes in the bath, before being cast in a lightly siliconized 70×140×3 mm hollow metal mold. The mold was interlocked, by means of a silicone seal, with a metal plate covered with a Teflon coating, then the assembly was introduced into a heated press preset to a temperature of 140° C. and firing was begun at a pressure of 10 bar. The firing was carried out for 17 hours.

A molar ratio of epoxide functions of the resin to anhydride functions of the curing agent respectively equal to 1/0.5; 1/0.8; 1/1 and 1/0.8 for samples 1a, 1b, 1c and 1 d was used to produce these samples.

The Tg and the storage modulus of the materials thus obtained were measured.

These materials exhibited respectively a Tg of 130° C., 148° C., 148° C. and 114° C. and a storage modulus at 200° C. of 15 MPa, 14 MPa, 15 MPa and 7.5 MPa.

Two samples of vitrimer material were prepared in an identical manner, with the TBD being replaced with DBU (1,8-diazabicyclo[5.4.0]undec-7-ene), or DOTG (diorthotolylguanidine), for a molar ratio of epoxide functions of the resin to anhydride functions of the curing agent equal to 1/1. These materials exhibited respectively a Tg of 132° C. and 125° C. and a storage modulus at 200° C. of 14 MPa and 10 MPa.

### Comparative Example 2

### Synthesis of an Epoxy-Anhydride Network in the Presence of 10% of Zinc Acetylacetonate

Three samples of material (respectively 2a, 2b and 2c) were prepared in a manner identical to example 1, except that the catalyst was replaced with zinc acetylacetonate or Zn(acac)₂ in a content of 10 mol % of Zn relative to the epoxy functions.

These materials exhibited respectively a Tg of 124° C., 142° C. and 130° C. and a storage modulus at 200° C. of 14.3 MPa, 14.5 MPa and 13.5 MPa.

### Comparative Example 3

### Synthesis of an Epoxy-Anhydride Network in the Presence of Nitrogenous Catalysts

Five samples 3a to 3e of material were prepared in a manner identical to example 1, using variable amounts of different epoxide opening nitrogenous catalysts not corresponding to formula (I) described herein, namely: methylimidazolidone (or 2-MIA), 2,4,6-tri(dimethylaminomethyl)phenol (hereinafter “Anc” for Ancamine K54 from Air Products) and 1,4-diazabicyclooctane (or DABCO). The molar ratio of epoxide functions of the resin to anhydride functions of the curing agent was set at 1/0.8. The characteristics of these materials are collated in table 1 below.

TABLE 1

| | 3a | 3b | 3c | 3d | 3e |
|---|---|---|---|---|---|
| Catalyst | 2-MIA | Anc | DABCO | DABCO | DABCO |
| Catalyst/epoxide | 2.5 | 2 | 1 | 5 | 10 |
| (mol %) | | | | | |
| G′ (MPa) | 15 | 10 | 7 | 11 | 10 |
| Tg (° C.) | 144 | 130 | 110 | 130 | 130 |

### Example 4

### Synthesis of an Epoxy-Anhydride Network in the Presence of TBD and of a Polyol

Three samples were prepared in a manner identical to the sample 1b of example 1, except that a polyol was added in liquid form to the curing agent at ambient temperature. The Tg and the storage modulus G′ of the materials thus obtained were measured, and are collated in table 2 below.

TABLE 2

| | Sample | | |
|---|---|---|---|
| | 4a | 4b | 4c |
| Polyol | Glycerol | Glycerol | TMP* |
| mol %_{OH/epoxy} | 10 | 20 | 10 |
| Tg (° C.) | 146 | 144 | 144 |
| G′ (MPa) | 15 | 15 | 16.7 |

*trimethylolpropane

### Example 5

### Study of the Vitrimer Properties of Various Materials

The samples of examples 1 to 4 were subjected to an experiment consisting in imposing, on a test specimen of material of 40×20×2 mm, a 3-point flexural deformation under a nitrogen stream, using a Metravib apparatus of DMA50N type, after the sample had been brought to a temperature equal to Tg+100° C. or to 200° C., and stabilized for 5 min at this temperature. The change in the stresses induced in the material in order to keep the deformation constant is monitored for 5000 seconds and measured using a sensor. A force equal to zero is then imposed on the sample and the deformation (recovery) of the sample is measured for a further 5000 seconds. When the material retains the deformation that was imposed on it, it is considered that all the stresses have been relaxed. The normalized stress (a/co) is then plotted as a function of time and, for each test, the relaxation time required to obtain a normalized stress value equal to 1/e, and also the percentage of stresses relaxed at 5000 seconds, hereinafter denoted σ₅₀₀₀ₛ, are recorded.

The results obtained are collated in table 3 below.

As emerges from this table, the catalysts according to the invention (samples 1a to 1d) make it possible to obtain materials capable of relaxing their stresses more completely and generally more rapidly than the materials obtained using a zinc acetylacetonate-based catalyst in a content of 10% (samples 2a to 2c). These vitrimer properties can be further improved by adding a polyol to the mixture of reagents (examples 4a to 4c). Moreover, they are not obtained to the detriment of the mechanical properties of the material, which exhibits a storage modulus (G′) at the rubbery plateau which is greater than or equal to 5 MPa (see example 1).

On the other hand, the materials of examples 3a to 3e do not exhibit vitrimer properties, unless a very high catalyst content is used (example 3e). Even in this case, the properties obtained remain mediocre.

TABLE 3

| | Sample | | | | | | |
|---|---|---|---|---|---|---|---|
| | | | | | 2a | 2b | 2c |
| | 1a | 1b | 1c | 1d | (comp) | (comp) | (comp) |
| τ (s) | 345 | 1015 | 1655 | 1555 | 1600 | 2400 | 1565 |
| σ_{5000 s} (%) | 96 | 100 | 100 | 93 | 100 | 87 | 84 |

| | Sample | | | | |
|---|---|---|---|---|---|
| | 3a | 3b | 3c | 3d | 3e |
| | (comp) | (comp) | (comp) | (comp) | (comp) |
| τ (s) | >5000 | >5000 | >5000 | >5000 | 2350 |
| σ_{5000 s} (%) | 0 | 0 | 28 | 54 | 82 |

| | Sample | | |
|---|---|---|---|
| | 4a | 4b | 4c |
| τ (s) | 385 | 315 | 670 |
| σ_{5000 s} (%) | 100 | 100 | 93 |

### Example 6

### Study of the Thermal Stability of Various Vitrimer Materials

The thermal stability of a material was evaluated, said material being identical to that of example 1 b, except that it was obtained using an amount of catalyst equal to 0.5 mol % relative to the number of moles of epoxide functions in the resin (hereinafter, example 1d). The results were compared to those obtained with the material of comparative example 2b. The measurement was carried out by TGA on a Perkin Elmer apparatus of TGA7 type, by performing a temperature scan from 25° C. to 500° C. according to a ramp of 10° C./min. The temperature resulting in a loss of material of 1% was 176° C. in the case of the material of comparative example 2b and 305° C. in the case of the material of example 1d. In addition, the loss of material after 1 h at 250° C. came to 8.4% in the case of the material of comparative example 2b and 1.5% only in the case of the material of example 1d. These results confirm the better thermal resistance of the materials according to the invention at the re-forming and recycling temperatures.

The tests carried out on the materials obtained in example 1 with DBU and DOTG showed that the temperature resulting in a loss of material of 1% was respectively 315° C. and 295° C., and the loss of material after 1 h at 250° C. came to 4.1% for DBU.

1. A composition comprising:
a catalyst comprising a compound of formula (I): 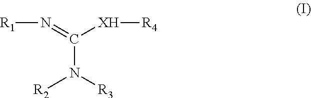
in which:
X denotes a nitrogen atom or a —CH— group,
R₁ denotes a hydrogen atom or a C₁-C₆ alkyl group or a phenyl group that optionally is substituted with a C₁-C₄ alkyl group,
R₂, R₃ and R₄ independently denote a hydrogen atom, a C₁-C₆ alkyl group, a phenyl group that optionally is substituted with a C₁-C₄ alkyl group, or an acetyl group,
or R₁ and R₂ form, together and with the atoms to which they are bonded, a saturated or unsaturated heterocycle and/or R₃ and R₄ form, together and with the atoms to which they are bonded, a saturated or unsaturated heterocycle,
a thermosetting resin comprising at least one epoxide function and optionally at least one free hydroxyl and/or ester function, and a thermosetting-resin curing agent selected from carboxylic acid anhydrides.

2. The composition as claimed in claim 1, wherein R₁ and R₂ form, together and with the atoms to which they are bonded, a saturated or unsaturated heterocycle, and wherein R₃ and R₄ form, together and with the atoms to which they are bonded, a saturated or unsaturated heterocycle.

3. The composition as claimed in claim 1, wherein the catalyst is triazabicyclodecene (TBD).

4. The composition as claimed in claim 1, wherein the catalyst represents from 0.1 to less than 5 mol %, relative to the molar amount of epoxy functions contained in said thermosetting resin.

5. The composition as claimed in claim 1, wherein the thermosetting resin is bisphenol A diglycidyl ether (DGEBA).

6. The composition as claimed in claim 1, wherein the amount of curing agent is such that the number of moles of epoxide functions of the thermosetting resin ranges from 50% to 300%, relative to the number of moles of anhydride functions of the curing agent.

7. The composition as claimed in claim 1, wherein the content of thermosetting resin and of curing agent ranges from 10% to 90% by weight, relative to the total weight of the composition, the remainder to 100% being provided by the catalyst and optionally by one or more additional compounds selected from the group consisting of: polymers, pigments, dyes, fillers, plasticizers, long or short, woven or nonwoven fibers, flame retardants, antioxidants, lubricants, wood, glass, metals, and mixtures thereof.

8. The composition as claimed in claim 1, additionally comprising at least one polyol.

9. The composition as claimed in claim 8, wherein the polyol is selected from glycerol, trimethylolpropane or pentaerythritol.

10. A kit for producing a composition as claimed in claim 1, comprising at least:
a first composition comprising the catalyst, alone or with the curing agent or the thermosetting resin;
optionally a second composition comprising the curing agent;
optionally a third composition comprising the thermosetting resin.

11. A process for producing an object made of thermoset resin that is hot deformable, comprising using the composition as claimed in claim 1.

12. An object comprising a thermoset resin obtained from a composition as defined in claim 1.

13. A process for deforming an object, comprising applying to an object in accordance with claim 12 a mechanical stress at a temperature (T) above the glass transition temperature Tg of the thermoset resin.

14. The use of one or more objects in accordance with claim 12 in the motor vehicle, aeronautical, nautical, aerospace, sport, construction, electrical, electrical insulation, electronics, wind power, packaging or printing fields.

15. The composition as claimed in claim 1, wherein the catalyst consists of the compound of formula (I).

16. The composition as claimed in claim 1, wherein the thermosetting resin is comprised of a plurality of epoxide functions.

17. The composition as claimed in claim 1, wherein the catalyst represents from 0.1 to 4 mol %, relative to the molar amount of epoxy functions contained in said thermosetting resin.

18. The composition as claimed in claim 1, wherein R₁ and R₂ form, together and with the atoms to which they are bonded, an unsaturated heterocycle, and wherein R₃ and R₄ form, together and with the atoms to which they are bonded, a saturated heterocycle.

19. The composition as claimed in claim 1, wherein the amount of curing agent is such that the number of moles of epoxide functions of the thermosetting resin ranges from 100% to 200%, relative to the number of moles of anhydride functions of the curing agent.

20. The composition as claimed in claim 1, wherein the content of thermosetting resin and of curing agent ranges from 20% to 80% by weight, relative to the total weight of the composition, the remainder to 100% being provided by the catalyst and optionally by one or more additional compounds selected from the group consisting of: polymers, pigments, dyes, fillers, plasticizers, long or short, woven or nonwoven fibers, flame retardants, antioxidants, lubricants, wood, glass, metals, and mixtures thereof.
